(19) United States
(12) Patent Application Publication
(10) Pub. No.: US 2024/0205013 A1
(43) Pub. Date: Jun. 20, 2024

(54) PRIVACY PRESERVING AUTHENTICATION AUGMENTED WITH PHYSICAL BIOMETRIC PROOF

(71) Applicant: International Business Machines Corporation, Armonk, NY (US)

(72) Inventors: Alessandro Sorniotti, Zürich (CH); Elli Androulaki, Zürich (CH); Julia Hesse, Langnau am Albis (CH); Jens Jelitto, Rueschlikon (CH); Ilie Circiumaru, Zürich (CH); Nitin Singh, BANGALORE (IN)

(21) Appl. No.: 18/319,115

(22) Filed: May 17, 2023

(30) Foreign Application Priority Data
Dec. 20, 2022 (GR) 20220101062

(51) Int. Cl. H04L 9/32; G06V 40/12; G06V 40/16; H04L 9/08

(52) U.S. Cl. CPC H04L 9/3231; G06V 40/1365; G06V 40/172; H04L 9/0819; H04L 9/3218

(57) ABSTRACT

A computer-implemented method for privacy preserving authentication augmented with physical biometric proof is disclosed. The computer-implemented method comprises providing an integrated smart entity comprising both, a visual indicator of a physical entity and a persistent memory storing picture identifier data. The visual indicator and the persistent memory are physically inseparable. The computer-implemented method further comprises comparing the visual indicator and a related feature of the physical entity to be authenticated, receiving an output value of a function having the picture identifier data as argument and a verifiable credential. Upon determining that the output value of the function and the received verifiable credential are satisfy a matching predicate, confirming the verifiable credential.

### BACKGROUND

The invention relates generally to a method for authentication, and more specifically, to a method for privacy preserving authentication augmented with physical biometric proof. The invention relates further to an authentication system for privacy preserving authentication augmented with physical biometric proof, and a computer program product.

Digitization is not only a mainstream trend in an industry context, but also in daily life. In this context, digital identities are becoming ever more popular. Through its various instances, it allows users to authenticate themselves to service providers/verifiers in a digital manner. However, one of the largest issues with this technology is privacy—in particular, also conflicts with GDPR (Europe's General Data Protection Regulation) regulations. The generation and exchange of digital bank statements can leave a digital trail of information about an individual which—if misused—may be used for illegal mass data collection. Other problematic areas are profiling, impersonation or identity theft.

As such, several solutions based on “zero-knowledge” (ZK) have been proposed. ZK-based systems may allow verification of the statement without forcing the prover to verify the data supporting those statements. As an example: verify the statement “Alice's of age” without revealing Alice's date of birth. Such technologies enable what is known as “selective disclosure”—where basically a subset of a set of certified attributes of the holder—may be presented to a verifier. Furthermore, predicates over these attributes might be generated to prove more complex concepts such as “complies with certain pandemic-related policies” or “is allowed to buy liquor” without disclosing a (possibly larger) set of personal attributes that would reveal private information unnecessarily to back up the statements.

Unfortunately, digital identifications (i.e., IDs) still seem to require the presentation of government ID (e.g., an ID card or passport or driver's license etc.) in order to link the digital ID to the person presenting it and to ensure that the person has not stolen the digital credential or is colluding with the intellect of the credential holder. An example can make this more comprehensible: The digital green certificate permits authorities from EU (and associated) countries to generate claims about the health of the certificate holder. They can be displayed and verified digitally, and yet, the trust framework requires the presentation of a government-issued ID to verify that: (i) the personal details in the certificate are identical to those in the ID, and (ii) that the picture on the government ID matches the person presenting it. This type of paper-based authentication has been the de-factor standard for a century or more. Therefore, it is assumed that this requirement can easily be replaced.

However, this requirement renders almost entirely useless all Zero Knowledge technologies (i.e., ZK-technologies) deployed to minimize data collection and correlation, since in the end, if a government-issued ID is presented, the verifier: (i) learns a lot of the personal details of the holder, and (ii) can correlate the attributes disclosed by the holder over time, and thus, fully profile the holder. In the analog world, this may still be acceptable since the verifier would need to store or memorize the personal data at the moment of presentation, whereas in a digital environment, it is trivial to store this information.

Thus, there is a need to address the issue of how to bind digital information to a holder in a way which is at least as secure as by presenting a government ID, without the associated privacy violations.

Several ways have been tried to enable this binding: The picture of the legitimate holder might be embedded in the credential itself. This way, in theory, as the digital credential is displayed, it carries the picture with it, which can be verified as its paper counterpart and which can be designed to be compliant with data reduction. However, this raises the questions of (i) how to make sure that the holder has not replaced the picture of the legitimate holder with their own and (ii) who performs the biometric match.

In some instances, the matching can be performed by the verifier directly. If the verifier performs the matching directly, the visual data may be either on the holder device or on the verifier device. If it's on the holder device, the holder may easily substitute the picture and so the solution is not a viable one. When it is sent to the verifier device, it creates a new privacy leak, because pictures of holders are always sent to verifiers. The verifiers can then collect these pictures and use them to link and profile users. Thus, this methodology would not be a viable way for solving the privacy dilemma.

In another implementation, the matching can be performed on a trusted device. If the device would be controlled by the holder, the issue is that it must be a technology or device that is available to the general public. Current trusted hardware on such devices (e.g., a smartphone) do not enable the kind of guarantees required by this scenario. For example, it may be necessary to confirm that the screen is being used to display the correct image or that a biometric matching is being performed against the correct image. Furthermore, there are cryptographic solutions to this, e.g., multi-party computation (MPC); but they are too expensive for general use. If the device is not under the control of the holder, pictures of the holder must be taken and handled by this device, which creates again an issue of data collection/profiling.

Two solutions in this context shall also be mentioned explicitly: A first solution discloses a national digital identity. It is based on an identity brokers system and a method for managing a national digital identification of a citizen. The method includes, but is not limited to, receiving, from a user device, an identity sharing request of a citizen including an identification of a service provider with which to share the identity and determine one or more digital identification credentials of the citizen that are to be shared with the service provider based on the identity sharing request. Furthermore, a second solution proposes methods for identification document verification using hybrid near-field communication authentication and optical authentication.

However, in order to summarize, a trivial solution either creates an insecure verification—i.e., verifiers, cannot be sure that they are matching the face of the user with the correct picture—or they create a new privacy leak—i.e., photos of the holder are sent to third-party devices—or they are too expensive, e.g., MPC. Consequently, the above-mentioned objective task continues to exist and the industry is looking for a solution.

### SUMMARY

According to one aspect of the present invention, a method for privacy preserving authentication augmented with physical biometric proof may be provided. The method may comprise providing an integrated smart entity comprising both, a visual indicator of a physical entity and a persistent memory storing picture identifier data, where the visual indicator and the persistent memory are physically inseparable and comparing the visual indicator and a related feature of the physical entity to be authenticated.

The method may also comprise receiving an output value of a function having a picture identifier (PID) as argument, and a verifiable credential. Upon determining that the output value of the function and the received verifiable credential are satisfy a matching predicate, the method may also comprise confirming the verifiable credential.

According to another aspect of the present invention, an authentication system for privacy preserving authentication augmented with physical biometric proof may be provided. The system may comprise an integrated smart entity comprising both, a visual indicator of a physical entity and a persistent memory storing picture identifier data, where the visual indicator and the persistent memory are physically inseparable, a holder unit and a verifier unit.

The system may also comprise a comparing device adapted for comparing the visual indicator and a related feature of the physical entity to be authenticated.

A scanner module may be connected to the verifier unit, where the scanner unit may be adapted to receive data from the integrated smart entity by scanning the integrated smart entity, thereby receiving an output value of a function having the PID as argument. Furthermore, a receiver may be connected to the verifier unit, where the receiver is adapted for receiving a verifiable credential.

Last but not least, the system may comprise a determination unit as part of the verifier unit adapted for upon determining that the output value of the function and the received verifiable credential are satisfying a matching predicate confirming the verifiable credential.

The proposed method for privacy preserving authentication augmented with physical biometric proof may offer multiple advantages, technical effects, contributions and/or improvements:

The proposed concept may overcome the limitations mentioned in the background section of this document, namely, it may enable a privacy preserving authentication of, e.g., a person. This means that the person would not have to provide a personal ID card with private information such as name, address, date of birth, place of birth and so on, a driver's license or a social security card to prove that the person really does have access in conjunction with a verifiable credential, such as a Covid pass, to a stadium or other secured places.

The prover may only present the integrated smart entity—e.g., and easy to use NFC card comprising an image of the holder's face and a memory chip with additional near-field wireless communication capabilities—and the verifier may compare the image shown with the holder's face. Not any additional private information would have to be disclosed to the verifier. Instead of the verifier being a person, also electronic equipment—like a camera and a respective image processing system—may compare the face of the holder and the image on the integrated smart entity.

It should also be mentioned that the proposed authentication process may also be used for other objects, not just people. In that case, a photo or image of that object/item should be displayed on the integrated smart entity.

The proposed concept may be fully compliant with government privacy regulations including GDPR. The handling would be easy and the issuance of the integrated smart entity would also be government controlled. Furthermore, the verification or authorization process may be performed with any requirement for wireline all wireless WAN communication. Actually, the authentication process may only need a holder device and a verifier device being adapted for a near-field communication. This can result in the proposed solution also being cost effective and with a high population acceptance factor.

This proposed solution is basically providing the best of both worlds: the analogue world and the digital world. The authentication takes place in both universes: Traditionally, in the physical-world authentication has been good for centuries from a biometric/privacy perspective because humans have to check pictures, e.g., on passports without violating the privacy of the individual. At the same time, it was a bad method from a data minimization perspective because every time one shows the passport, one discloses all data at once.

On the other side—in the digital world—a digital solution is good from a data minimization perspective but bad from a biometric/privacy perspective because it typically results in data collection and profiling.

With the newly proposed solution, one may have both: IN the physical world the only information disclosed to the verifier is the picture and nothing else. And in the digital world the proposed solution does not process the full authentication. It thus relies on a defined breaking point between the two worlds: The human inspection process.

However, the image/face inspection process may also be a digital pattern matching process step. However, in case some of the benefits of the proposed concept get lost.

In the following, additional embodiments of the inventive concept—applicable for the method as well as for the system—will be described.

According to one advantageous embodiment of the method, the integrated smart entity may be a near-field communication (NFC) card. This may be produced like a passport or a credit card with an embedded chip so that the visual indicator of a physical entity—e.g., an image of a person's face when the physical entity is a person—and a persistent (or permanent) memory storing picture identifier data, e.g., a unique code that cannot be separated without destroying the integrated smart entity. The integrated smart entity may also comprise additional electronic components to activate the NFC chip embedded in the card. This may enable a scanning of the integrated smart entity—i.e., activating the NFC chip in order to execute a predefined routing—e.g., in order to extract, e.g., (i) the unique picture identifier data or (ii) the output value of a function having the picture identifier data as argument (i.e., a commitment). Option (ii) would be a prerequisite for a zero knowledge proof authentication.

Alternatively, the integrated smart entity may also be an RFID card (radio frequency identifier card) which may also have an integrated memory for storing the picture identifier data and electronic circuits for reading out data like the output value of the function having the picture identifier data as argument; and the card—e.g., plastic—may also have the visual indicator (e.g., an image) permanently attached to it.

According to a preferred embodiment of the method, the received verifiable credential received by the verifier unit was sent by a holder unit. Thus, the communication between the verifier unit and the holder unit may be a direct one without the requirement for an online network connection in order to be able to verify the credential. This may make the proposed concept Wireless Internet independent. The communication between the verifier unit and the holder unit can be done via local Bluetooth, an NFC protocol, by infrared signals or other means of local electronic communication.

According to a useful embodiment of the method, the visual indicator may be an image of a person, an image of a person's face, an image of a person's finger print, an image of an object, an image of a text, an image of a pictogram, a bar code, and a QR-code or any other visible feature that can visually be matched—either content-wise or pixel-wise—against another object. In general, a visible object or feature of an object (either non-living material or alive) may be identified and matched against the visible indicator of the embedded smart entity, i.e., the card. It may also be used to identify a specific container in a logistics center, wherein the container may have a specific appearance, a QR code printed on the door, or any alphanumeric label, just to name a few examples. Therefore, the proposed concept may be used in a variety of product embodiments. Thereby, the matching between the real object and features thereof and the image or visual indicator as part of the integrated smart entity can be done fully automated using a camera in pattern matching technologies, including OCR and artificial intelligence-based methods or, the matching can also be performed by a human just by looking at the image of the integrated smart entity and the real object.

According to a further preferred embodiment, the method may also comprise issuing, by a first trusted authority—in particular, a government body as issuer—the integrated smart entity with a unique picture identifier (PID) code stored in the persistent memory of the integrated smart entity. Furthermore, according to the same or another embodiment, the method may also comprise issuing, by a second trusted authority, the verifiable credential. Thereby, one attribute of the verifiable credential may be the unique picture identifier code.

The first trusted authority and the second trusted authority may be identical (or belonging to the same government body) or, they may be different, which may require that the first trusted authority and the second trusted authority—or better the related systems operated by the trusted authorities—communicate with each other so that the unique picture identifier may become the attribute of the verifiable credential. One example of such verifiable credential may be a medical digital identification credentials allowing people access to facilities only after meeting specified criteria.

According to an enhanced embodiment, the method may also comprise generating, by the trusted authority, a key pair of a signature scheme that supports an efficient signature proof of knowledge and a selected disclosure of a subset of related messages, and sharing a related verification key with the holder unit and the verifier unit. Examples of the signature scheme might be BBS+, CL, or PS. This key pair with signatures may be used in one of the zero knowledge proof protocols in order to authorize the real world entity behind the visual indicator of the integrated smart entity. However, also other key pairs and/or signatures may be used instead.

According to one optional embodiment of the method, the first trusted authority issuing the integrated smart entity and the second trusted authority issuing the verifiable credential may either be the same trusted authorities or different trusted authorities. This may also support the privacy aspect and the compliance with e.g., GDPR (General Data Privacy Rules) or other privacy government regulations of the concept proposed here.

According to a smart embodiment of the method, the holder unit may be a smartphone, and/or also the verifier unit may be a smart phone. No special equipment may be required in order to support the proposed method. However, the implementation would be comparatively easy, because also verify the certificates—such as the Covid pass—are typically available as part of a smartphone app. Due to the also proposed communication concepts between the smart phones, the proposed method may also work in areas, in which often no or only unreliable wireless WAN connection is possible, e.g., inside buildings.

According to a further developed embodiment of the method, the determining, by the verifier unit, that the output value of the function—having the PID as argument—and the received verifiable credential may satisfy the matching predicate, a Fiat-Shamir transformed Schnorr proof of knowledge algorithm may be used. This may be an advantageous algorithm because executable code may be directly available; however, also other ZKP (zero knowledge proof) concepts can be used instead.

According to a permissive embodiment of the method, the holder unit and/or the verifier unit may be one selected out of the group comprising a smart watch, a table computer, a notebook computer or a dedicated device for authentication purposes. Hence, the named units are not limited to smartphones but also other programmable devices being adapted to execute the respective program code. This can significantly expand device flexibility.

Furthermore, embodiments may take the form of a related computer program product, accessible from a computer-usable or computer-readable medium providing program code for use, by, or in connection, with a computer or any instruction execution system. For the purpose of this description, a computer-usable or computer-readable medium may be any apparatus that may contain means for storing, communicating, propagating or transporting the program for use, by, or in connection, with the instruction execution system, apparatus, or device.

### BRIEF DESCRIPTION OF THE DRAWINGS

It should be noted that embodiments of the invention are described with reference to different subject-matters. In particular, some embodiments are described with reference to method type claims, whereas other embodiments are described with reference to apparatus type claims. However, a person skilled in the art will gather from the above and the following description that, unless otherwise notified, in addition to any combination of features belonging to one type of subject—matter, also any combination between features relating to different subject—matters, in particular, between features of the method type claims, and features of the apparatus type claims, is considered as to be disclosed within this document.

The aspects defined above and further aspects of the present invention are apparent from the examples of embodiments to be described hereinafter and are explained with reference to the examples of embodiments, to which the invention is not limited.

Preferred embodiments of the invention will be described, by way of example only, and with reference to the following drawings:

FIG. 1 shows a block diagram of an embodiment of the inventive method for privacy preserving authentication augmented with physical biometric proof.

FIG. 2 shows a block diagram of an embodiment of the setup between an issuer, a holder and a verifier.

FIG. 3 shows devices required for the privacy preserving authentication, in accordance with an embodiment of the present invention.

FIG. 4 shows a communication diagram for the integrated smart entity issuance, in accordance with an embodiment of the present invention.

FIG. 5 shows a communication diagram for the verifiable digital certificate issuance, in accordance with an embodiment of the present invention.

FIG. 6 shows a communication diagram between constituents of the authentication process, in accordance with an embodiment of the present invention.

FIG. 7 shows a block diagram of the authentication system for privacy preserving authentication augmented with physical biometric proof, in accordance with an embodiment of the present invention.

FIG. 8 shows a block diagram of an embodiment of a computing system comprising the authentication system according to FIG. 7.

### DETAILED DESCRIPTION

In the context of this description, the following technical conventions, terms and/or expressions may be used:

The term ‘integrated smart entity’ may, e.g., denote a type credit card sized smart card comprising the visual indicator on its surface and a memory chip inside. The visual indicator and the memory chip for persistent storage shall not be separable without destroying the integrity of the integrated smart entity.

The term ‘visual indicator’ may denote an image of a person (or as subject) to be authenticated.

The term ‘physical entity’ may denote—as an alternative to a person to be authenticated—also a physical device. However, on the other side, here, the physical entity may also denote a person, and more concrete the holder of the holder unit.

The term ‘persistent memory’ may denote an electronic storage adapted to store certain digital codes such as a picture identifier (PID) and a seed code. Advantageously, the persistent memory may be integrated into surrounding electronic devices allowing a wireless, near-field activation of and communication with the persistent memory in order to read out the stored codes.

The term ‘verifier unit’ may denote an electronic device being adapted to execute parts of the protocol required for the authentication process. This may, e.g., be a smart-phone or a comparable device such as a smart-watch, a tablet computer or similar.

The term ‘output value of a function’ may denote a result of a mathematical operation (which may also be based on a lookup table) that is not one-to-one invertible. Typically, such operations are used for determining a commitment.

The term ‘picture identifier’ (PID) may denote a secret code stored in the persistent memory of the integrated smart entity, e.g., the NFC card. The picture identifier may be unique, i.e., there are no two individual picture identifiers having the same secret code. Furthermore, the issue us are trusted to only use it when dealing with this specific individual it refers to. And the PID can be a simple string—which is never used in the clear during the execution of the protocol—as it must be used in the context of a more complex cryptographic protocol designed to convince the verifier that the holder (i) has an integrated smart entity with a PID, (ii) a credential from a trusted issuer and that one attribute of that credential is identical to the PID, and (iii) none of the PID's is passed (leaked) to the verifier as they could otherwise be used for profiling. Not to forget: The PID must be unique in any case!

The term ‘verifiable credential’ may denote any document or security code allowed to be used by the holder of the verifiable credential. This may be, e.g., a health status certificate, and entrance parts to a secured area or any other sort of document with a link to the owner or holder.

The term ‘satisfying a matching predicate’ may denote a status, in which to electronic codes (all similar) all attesting to forming “build two sides of the same coin”, are associated to each other, certainly relate to each other in a predefined way or have a different relationship to each other that ensures that one has to be proved for the validity of the other.

The term ‘trusted authority’ may denote an institution fulfilling the criteria of being trusted by a plurality of parties, particularly a verifier to which or to which electronic unit a verifiable credential may be presented by a holder.

The term ‘BBS+key pair’ may denote a key pair compliant to the BBS+signature Suite created in 2020 for the Data Integrity specification by W3C. The Signature Suite utilizes BBS+signatures to provide the capability of zero knowledge proof disclosures. Alternative protocols that might be used are CL or PS.

The term ‘holder unit’ may denote a device similar in function but with different executable program code to the verifier unit.

In the following, a detailed description of the figures will be given. All instructions in the figures are schematic. Firstly, a block diagram of an embodiment of the inventive method for privacy preserving authentication augmented with physical biometric proof is given. Afterwards, further embodiments, as well as embodiments of the authentication system for privacy preserving authentication augmented with physical biometric proof will be described.

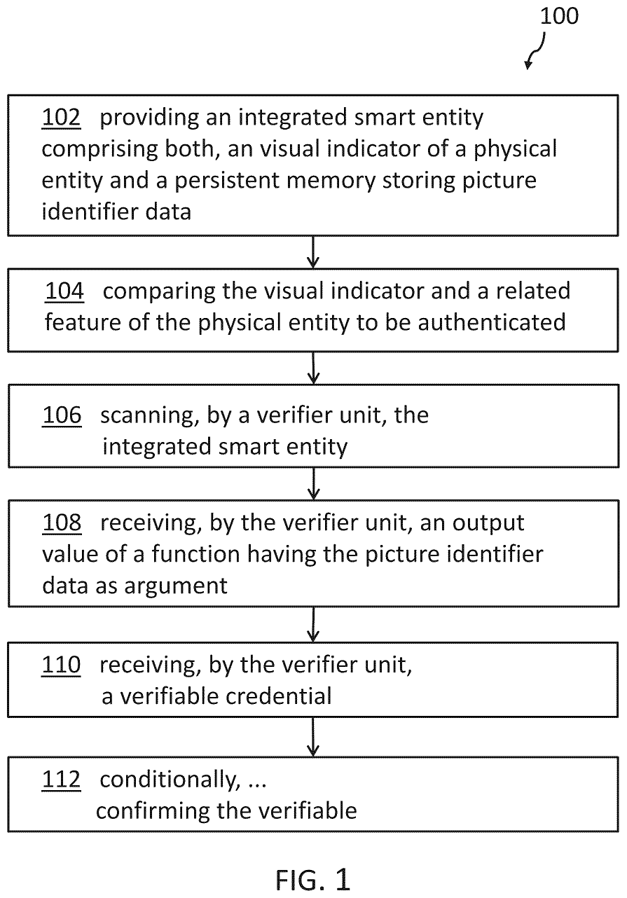

FIG. 1 shows a block diagram of a preferred embodiment of the method 100 for privacy preserving authentication augmented with physical biometric proof. The method comprises providing, 102, an integrated smart entity. This may be, e.g., a smart picture in the form of an, e.g., credit card sized card, e.g., in the form of an NFC card (near-field communication).

This integrated smart entity or smart picture card is a visual indicator of a physical entity of an observable feature image, a picture, a text, a pictogram, etc., which may be human observable but which may also be recognizable by a camera and a related electronic component for image processing. The integrated smart entity should not comprise any other text disclosing private information of the holder of this smart picture card, like their address, date of birth and so on.

Furthermore, the integrated smart entity or smart picture card also comprises a persistent memory storing picture identifier data (PID) which is not the picture itself but only a reference to it. Thereby, the visual indicator and the persistent memory are physically inseparable.

The method 100 also comprises comparing, 104, the shown or presented visual indicator and a related feature of the physical entity—e.g., the face of the holder—to be authenticated.

It should also be understood that not a human has to do the matching between the image of the face on the NFC card (i.e., the integrated smart entity) and the face of the holder (just to name an example). Instead, also a pattern matching camera/control unit may be used for a fully automated authentication process. This may also guarantee that no subjective influences determine the outcome of the authentication process.

Then, the method 100 comprises scanning, 106, the integrated smart entity by a verifier unit—, e.g., a verifier mobile app, and receiving, 108, an output value of a function having the PID as argument by the verifier unit.

Next, the method 100 comprises receiving 110, a verifiable credential by the verifier unit. This may also be performed by an app (i.e., executable smart device application) installed on the verifier unit. The verifiable credential would typically be sent from the holder device, e.g., also a smartphone with a respective app. As an example, the verifiable credential may be the Covid pass, the related QR code or similar.

In more practical words: The verifier scans a commitment to the PID and a zero-knowledge proof of knowledge of the opening of that commitment.

Then, a determination is made at the verifier unit: upon determining, 112, that the output value of the function and the received verifiable credential satisfy a matching predicate—i.e., equal or related to each other or associated to each other or connected together—the verifiable credential is confirmed. Hence, the authentication procedure ended successfully.

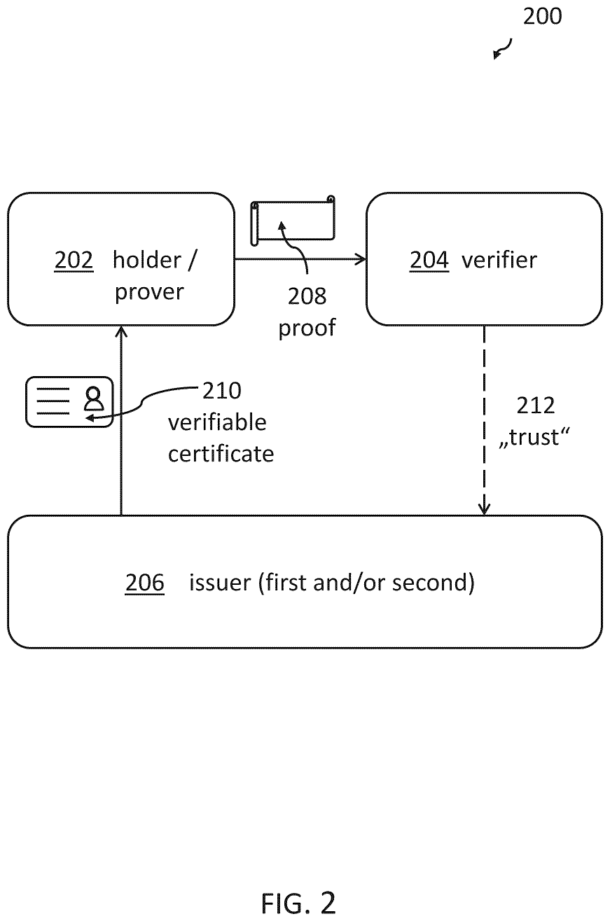

FIG. 2 shows a block diagram of an embodiment of the setup 200 between an issuer 206, a holder 202 and a verifier 204. As an example, the issuer 206 may be a government body, the holder or prover—or better a related device such as a smart phone—may be a visitor of a concert and, the verifier—or better a related device like, a smart phone—may be security personnel ensuring that no one without a digital identification credential that has been verified may enter the concert area or a football stadium or an airplane, or the like.

Typically, the issuer 206—which may be the first and/or the second issuer—may issue the verifiable certificate 210 to the holder 202. This certificate would then be shown to the verifier 204 together with a proof 208 that the certificate and the holder or prover 202 belong together. The setup is a workable solution because the verifier 204 trusts, 212, the issuer that the certificate is valid. However, the proof 208 is typically a passport in traditional setups so that the verifier 204 knows who the holder 202 really is. The situation should be avoided although the authentication process should continue to work.

In this context, it is also useful to discuss the lifecycle of the integrated smart entity, also denotable as smart picture. It is issued by a government body or similar trusted issue authority to a user, called the holder. When the holder receives a digital credential, this credential also comprises the PID, thus binding a user's digital credential with the identifier of the user's smart picture. The holder carries the smart picture around and uses it to authenticate himself to verifier, in particular upon verification, the holder and the verifier interact as follows: the holder shows the smart picture to the verifier; the traditional matching of the picture with an individual is carried out by the verifier and in analog way. However, also digital solutions are possible here. However, the preferred form would be that no digital devices should be used to generate digital traces under privacy law. After the verifier is convinced that the holder is the same as the one of the picture, the digital exchange of credentials can start.

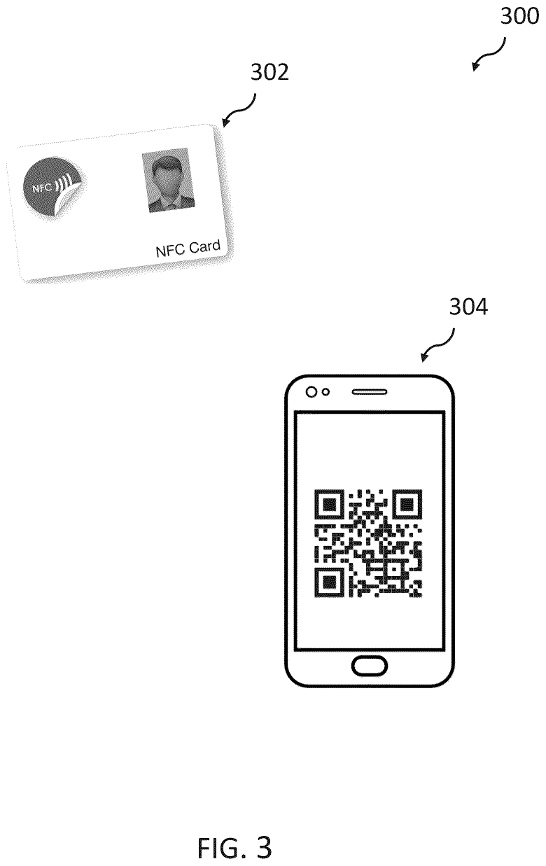

FIG. 3 shows devices 300 required for the privacy preserving authentication. In order to execute a successful authentication process without disclosing any private information, the prover only needs to present his integrated smart entity 302, e.g., an NFC card showing an indicator of a physical entity which is shown here as an image of the holder's face. The persistent memory of this, e.g., credit card sized NFC card can be integrated into the card is in commercially available NFC cards. This is also true for related electronic circuitry for a read-out of the memory of the NFC card. Additionally, the prover would need a smart device 304, e.g., a smart phone with an appropriate app, having a certificate included, here shown as QR code.

On the other side, the verifier would only need a smart device 304, e.g., also a smartphone with an appropriate app. It should also be noted that during the process of the authentication no wireless WAN network connectivity from the involved smartphones to any central server would be required. Furthermore, also other electronic devices may be used by the holder and the verifier.

In order to start this process, the following prerequisites should be met: The verifier unit should know the public keys of all trusted issuers. The holder possesses one or more verifiable credentials, each signed by one of the trusted issuers. Each credential certifies a set of attributes. And without loss of generality, it is assumed that the first attribute is always the PID.

The integrated smart entity—or smart picture—possesses a secret input that allows generating proof that convinces verifiers that the smart picture (or integrated smart entity) is associated with a specific verifiable credential. The Association is verified by comparing the PID of the smart picture and that in the verifiable credential.

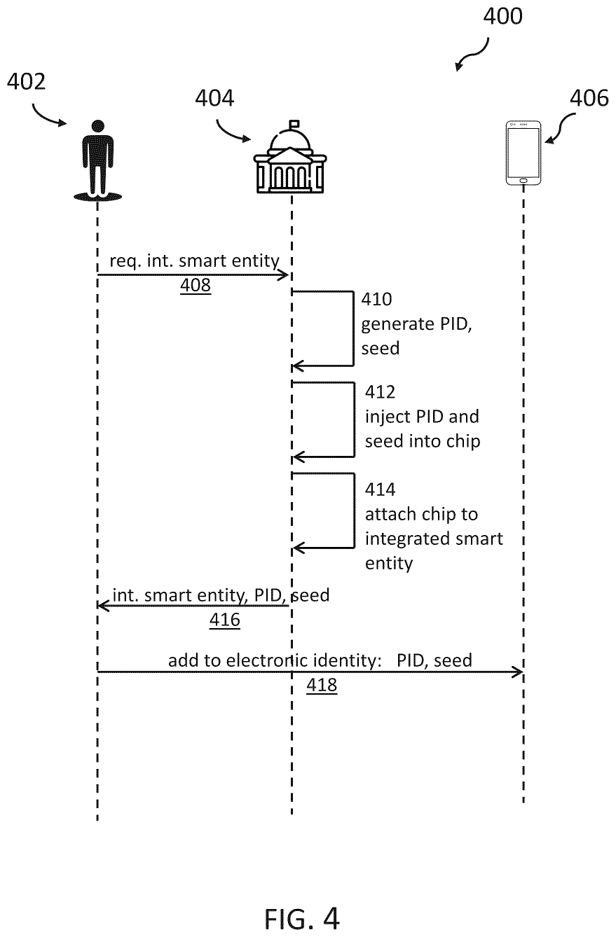

FIG. 4 shows a communication diagram 400 for the integrated smart entity issuance process. There are three involved constituents shown: the holder 402, an issuer 404 (typically a government body) and a holder smartphone app 406, typically installed on or in a holder unit.

The process starts with requesting, 408, the integrated smart entity by the holder 402 from the issuer 404. This or a related system generates, 410, a PID (picture identifier) and a seed. Both will be injected, 412—i.e., persistently stored in the memory—into the NFC chip. In case of other technologies, other communication protocols and memory chips may be used (e.g., in case of an RFID card). Then, the NFC chip is integrated, 414, into the integrated smart entity so that the visual indicator (e.g., the image) on the surface of the NFC card and the integrated NFC chip would not be separable without destroying the card.

Next, the integrated smart entity together with a PID and the seed is returned, 416, to the holder 402. In return, the holder 402 adds, 418, the PID and the seed to his electronic identity data on his smartphone or, a respective app.

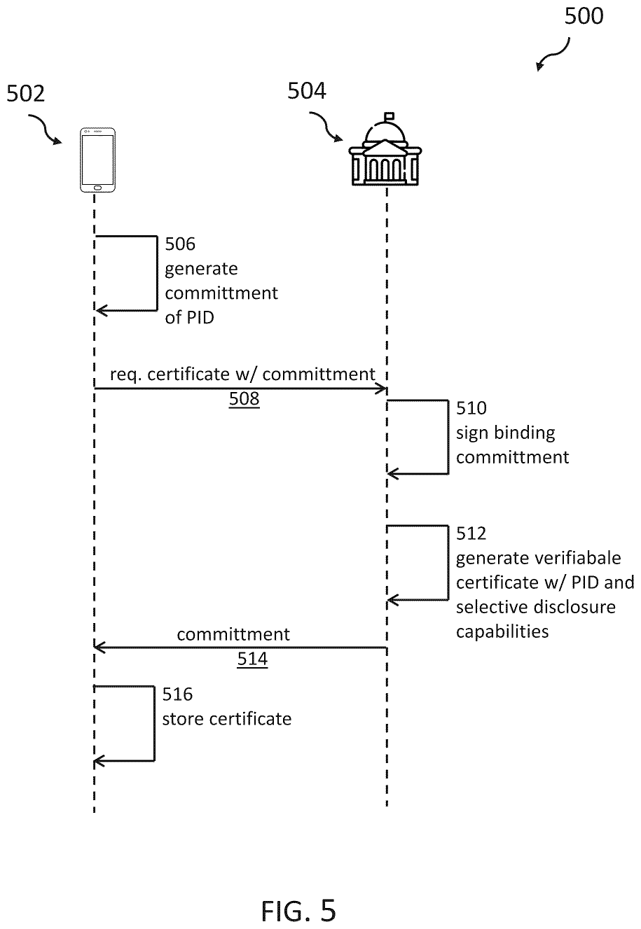

FIG. 5 shows a communication diagram 500 for the verifiable digital certificate issuance. Here, the acting units are the holder mobile app 502, e.g., in a smart phone and the certificate issuer 504. Firstly, the holder mobile app 502 generates, 506, a commitment of the PID. Then, the holder mobile app 502 requests, 508 a certificate from the certificate issuer 504. This may be the same government body as the issuer 404 in FIG. 4. However, this is not a requirement. The issuer of the certificate may be a different entity compared to the integrated smart entity issuer.

In the next step, the certificate issuer—or better, a related system—signs, 510, the commitment blindly and then generates, 512, a verifiable certificate with a PID commitment and selective disclosable capabilities. Then, the certificate is returned, 514 back to the holder mobile app 502. Here, the certificate is stored, 516, in the persistent memory of the related smart phone.

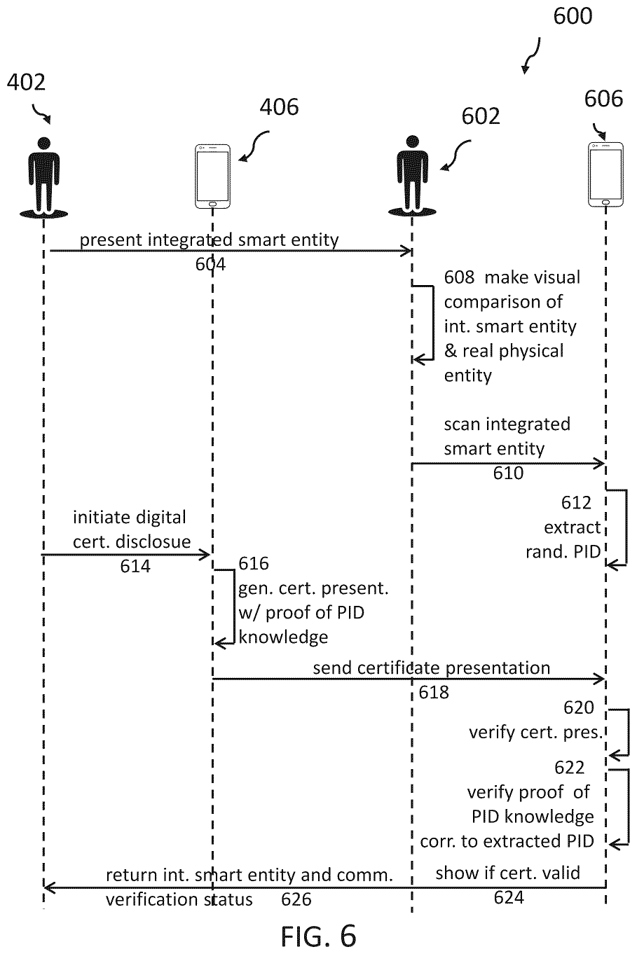

FIG. 6 shows a communication diagram 600 between constituents of the authentication process. The holder 402 shows (presents), 604) the integrated smart entity 406 to the verifier 602. The verifier 602 verifies, 608, that the picture of the holder on the integrated smart entity matches visually the holder. If not, the protocol aborts.

Then the verifier 602 with the verifier unit 606 scans, 610, the NFC chip of the integrated smart entity and receives (extracts), 612, a randomized ID: The randomized ID can be instantiated multiple ways, some of which will be described later on.

At this point, the holder/holder unit sends, 618 the verifiable credential to the verifier. Before, the holder 402 has initiated, 614, the digital certification disclosure and has generated, 616, a certificate representation with proof of a PID knowledge, the verifier unit 606 receives it and submits the following input for its verification: (i) the randomized ID (received from the integrated smart entity), (ii) the verifiable credential (received from the prover/holder unit), and (iii) the root of trust (e.g., the public key of the issuer, retrieved from a trusted repository). The verification app on the verifier unit 606 returns, 626, an “authentication okay” (624) if the credential is valid and issued by one of the trusted issuers, and if the PID from which the randomized ID is generated and the PID certified in the certifiable credential (620) match, 622.

Up to this point, a generic instance of the protocol has been described.

So, on a high level, the protocol operates as follows:
The issuer generates system parameters for a multi-message signature scheme, a commitment scheme and a zero knowledge proof system;
The issuer publishes the public parameters
The issuer generates a random PID and installs it in the card, along with the public parameters
The issuer generates a signature for the holder/user, signing all of the user attributes; notably, the first (wlog) attribute is the PID of the card of the user
When the holder/user wants to authenticate to a verifier with a card (integrated smart entity), it (or the holder unit, respectively) does the following
The verifier scans the card; the card responds with a binding and hiding commitment to PID;
the verifier then challenges the holder with the commitment received in the previous step,
requesting the disclosure of a subset of the certified attributes;
the holder responds with a zero-knowledge proof of knowledge of the signature
from the issuer, such that the commitment from the card “cancels out” the signed PID
attribute
the verifier verifies the proof of knowledge

It should be noted that for comprehensibility reasons the holder unit and verifier unit is here termed holder and verifier; however, the respective devices drive the related activities under the control of the respective holder person and verifier person.

In the following, a specific instantiation of the protocol will be described without using reference numerals. Thereby, the protocol is described as using BBS signatures, Pedersen commitments and Schnorr-style proofs of knowledge. Other instantiations, where the signature scheme is replaced by CL signatures or PS signatures are also possible.

The PID is a unique identifier of the picture in the integrated smart entity. For a protection of the PID, the system uses a key pair of a signature scheme that supports an efficient signature proof of knowledge and a selected disclosure of a subset of related messages, and sharing a related verification key with the holder unit and the verifier unit, e.g., BBS+, CL or PL (see above). Each issuer therefore generates public parameters that include a public key, groups and bases; assumed is wlog. It is also assumed that the bases of all issuers are identical; different bases may be handled trivially.

The randomized ID mentioned above is implemented as a Pedersen commitment to the PID.

The integrated smart entity comprises the following information: (i) the PID and (ii) a PRF seed s. These following two bases are required to generate the randomized ID (the Pedersen commitment to the picture identifier): (i) the base g_{pid} that is used for the PID, (ii) another base h_{pid} that is used to randomize the commitments, (iii) credentials are issued, e.g., as BBS+ signatures. All attributes of the holder are different messages that are signed; in particular, the first message is always reserved for the PID of the integrated smart entity of the holder.

When a credential is issued, the issuer retrieves the PID of the holder and uses it as the first message to generate the credential (=the signature). The rest of issuance proceeds as performed such as in classic comparable processes.

The holder/holder unit possesses all credentials issued to them (and possibly, secret key material to prove holder binding), the PID of their integrated smart entity/smart picture, the PRF seed s of their smart picture, and all other public key material (including bases).

When a credential is presented, the integrated smart entity is scanned and a prove protocol is executed (a bit shortened):

The Prove protocol involves a card C, a holder H and verifier V. The verifier specifies a set D⊆{2, . . . , L} of target attributes and a vector m′=(m₁, . . . , m_{L}) of target attribute values. The protocol involves C and H showing possession of issuer I's signature on m=(m₁, . . . , m_{L}) such that mᵢ=mᵢ′ for i∈D. It should also be noted that m₁ is identical to the PID on the card (i.e., integrated smart entity). More details are explained below.

1. Public Parameters: Groups G₁, G₂ and Gr of prime order p with bi-linear map G₁×G₂→G_{T}. Independent generators g₁, h₀, . . . , h_{L}∈G₁ and g₂∈G₂.

2. Issuer Parameters: Issuer publishes public key w=g₂^{x}∈G₂ for x←Zₚ, and also publishes a pair (⁻g₁, ⁻g₂) where ⁻g₁←Z and ⁻g₂=⁻g₁^{x}. The pair (⁻g₁, ⁻g₂) is only used by the zero-knowledge simulator to simulate the proof of knowledge.

3. Augmented Public Parameters: Here, the combined parameters as part of initial setup and those published by the issuer are denoted as augmented public parameters.

4. C's inputs: uid. (C=card, i.e., integrated smart entity);

5. H's inputs: m=(uid, m₂, . . . , m_{L}), Q=h₁^{uid}, σ=(A, e, s) where
A=(g₁·h₀^{s}·h₁^{uid}·Π^{L}ᵢ₌₂hᵢ^{m_i}) to the power of 1/(e+x).

6. Prove protocol between C, H and V.
(a) V→H: D⊆={2, . . . , L} and m′=(m′₁, . . . m′_{L}). Let ⁻D denote the set {2, . . . L\D}.
(b) C→V: C samples r←Z, computes C=h₁^{uid}h₀^{r} and sends C, π₁ to V. Here, π₁ denotes the Fiat-Shamir transformed Schnorr proof of knowledge of opening for the commitment C.
(c) C→H: C sends commitment randomness r to H.
(d) V→H: V forwards the commitment C to H.
(e) H the holder prepares the terms for the proof of knowledge of the signature from the issuer by randomizing the signature: namely

r₁←Z*ₚ,r₂←Zₚ,r₃=1/r₁

b=g1·h₀*·Q·Π^{L}ᵢ₌₂hᵢ^{m_i}

A′=A^{r_1},⁻A=A′^{-c}·b^{r_1}(=A′^{x})

d=b^{r_1}·h₀^{-r_2},s′=s−r₂r₃—r
(f) H→V: H sends A′, ⁻A, d to V in addition to the proof of knowledge 12 showing knowledge of a valid signature from the issuer over the set of disclosed messages, additionally proving knowledge of the random terms r₂ and r₃ and of e and s′, of the set of undisclosed messages, and proving that the multiplicative inverse of the commitment C received from the card cancels out with the component of the signature for the PID. This effectively proves that the PID of the card and that of the signature are identical. Expressed in formal language:

H→V: H send A′, ⁻A, d to V in addition to the proof of knowledge 12 showing knowledge of {mᵢ}_{i∉D}, r₂, r₃, e, s′) satisfying

A′^{-e}·h₀^{r_2}=⁻A/dΛd^{-r3}·h₀s⁻′·Π_{i∈}_{^{−}}_{A}hᵢ^{m_i}=g₁⁻¹·C⁻¹·Π_{i∈D}hᵢ^{m_i}.

It can be shown by calculation that the quantities computed by H in the previous step satisfy the above relations.
(g) V checks: The verifier V outputs 1 if e(A′, w)=e(⁻A, g₂) and proofs that way π₁ and π₂ are valid. Else it outputs 0. Hence, in case of “1” the authentication is confirmed.

In other words and in short: The issuer signs the PID term as one of the messages it signs. It follows a proof of knowledge of the issuer signature, i.e., the multiplicative inverse of the commitment to the PID received from the card (i.e., integrated smart entity) in step (b) “cancels out” with the respective term in the signature.

Next, the holder unit can prove knowledge of the rest of the messages that are not disclosed. It shall also be mentioned that the issuer signs PID1 as one of the messages, the card commits to PID2, and the verifier attempts to cancel out the term in PID1 with the term in PID2; and the two cancel out only if PID1=PID2, which represents a match.

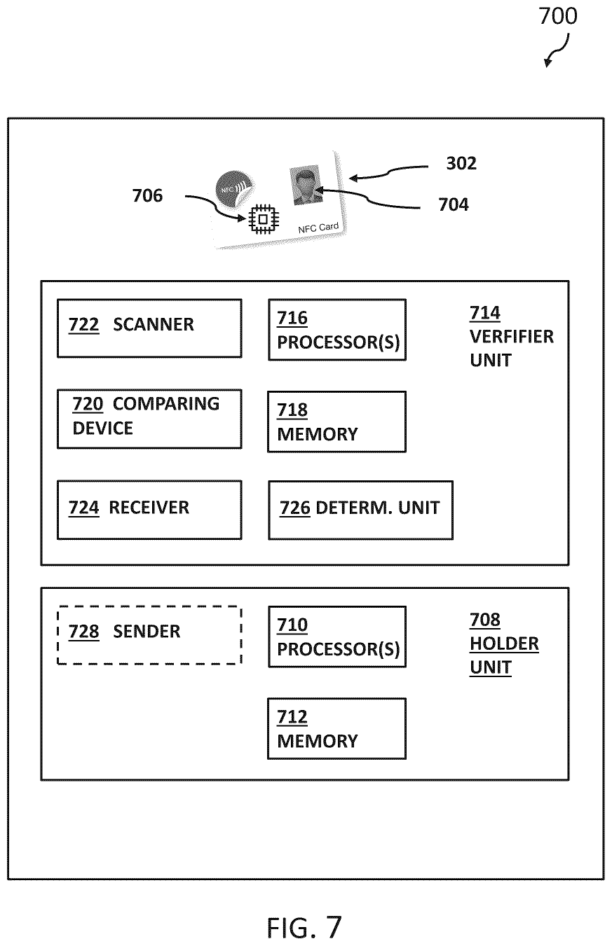

Before continuing with a description of FIG. 7, the following remark may also be considered:

The integrated smart entity (i.e., smart picture) doesn't have to just be a picture. It could also be a traditional government-issued photo ID in an enhanced version, together with a sleeve that visually blocks other personal details.

The NFC protocol might be augmented to also prove that the ID is genuine by appending to the payload from the NFC a signature from the issuer (e.g., the state) to convince the verifier/verifier unit that the smart picture is genuine.

As also briefly mentioned, the proposed concept generalizes beyond just pictures, and can be used to link_ANY_holder-owned device that can be augmented with tamper-resistant or tamper-proof NFC with a digital authentication process.

Issuers of digital certificates need to receive the PID so that they can embed it in the credential they issue; they may obtain this from an internal database (e.g., a state-database of issued picture identifiers) or from the holder directly, by displaying the integrated smart entity (i.e., the smart picture), receiving the randomized ID and asking the holder to provide proof of knowledge of the underlying (undisclosed ID).

The integrated smart entity can be generated by combining a face image and a fingerprint digital value. This will allow, during the audit, to prove that a specific requester has indeed used the respective integrated smart entity and he was allowed to use it (e.g., in case of twins, a simple picture is not valid evidence). Moreover, in 20 years technology might permit effortless creation of the very natural masks based on images from the Internet.

FIG. 7 shows a block diagram of the authentication system 700 for privacy preserving authentication augmented with physical biometric proof. The system comprises an integrated smart entity 302 (compare FIG. 3) comprising both a visual indicator 704 of a physical entity and a persistent memory 706 storing at least picture identifier data. Thereby, the visual indicator 704 and the persistent memory 706 are physically inseparable.

The authentication system 700 also comprises a holder unit 708 comprising a holder unit processor 710 and a holder unit memory 712 communicatively coupled to the holder unit processor 710, wherein the holder unit memory 712 stored executable code segments which, when executed by the holder unit processors 710 portions of executable program code enabling the privacy preserving authentication.

The system 700 also comprises a verifier unit 714, comprising a verifier unit processor 716 and a verifier unit memory 718 communicatively coupled to the verifier unit processor 716, wherein the verifier unit memory 718 stored executable code segments which, when executed by the holder unit processors 716, portions of the executable program code enable the privacy preserving authentication.

The system 700 also comprises a comparing device 720 adapted for comparing the visual indicator 704 and a related feature of the physical entity to be authenticated. The comparing device 720 may either be connected to or integral part of the verifier unit 708.

The system 700 also comprises a scanner module 722 connected to or as integral component of the verifier unit 714, wherein the scanner unit 722 is adapted to receive data from the integrated smart entity 302, by scanning the integrated smart entity 302, thereby receiving an output value of a function having the PID as argument.

The system 700 also comprises a receiver 724 connected to the verifier unit 714, wherein the receiver is adapted for receiving a verifiable credential, e.g., sent by the holder unit using an integrated sender 728.

Furthermore, the system 700 comprises a determination unit 726 as part of the verifier unit 714 adapted for: upon determining that the output value of the function and the received verifiable credential satisfy a matching predicate, confirming the verifiable credential.

It shall also be mentioned that all functional units, modules and functional blocks of the holder unit as well as the functional units, modules and functional blocks may respectively be communicatively coupled to each other for signal or message exchange in a selected 1:1 manner. Alternatively, the functional units, modules and functional blocks can be linked to a unit internal bus system (not shown) for a selective signal or message exchange.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (CPP embodiment or CPP) is a term used in the present disclosure to describe any set of one, or more, storage media (also called mediums) collectively included in a set of one, or more, storage devices that collectively include machine readable code corresponding to instructions and/or data for performing computer operations specified in a given CPP claim. A storage device is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

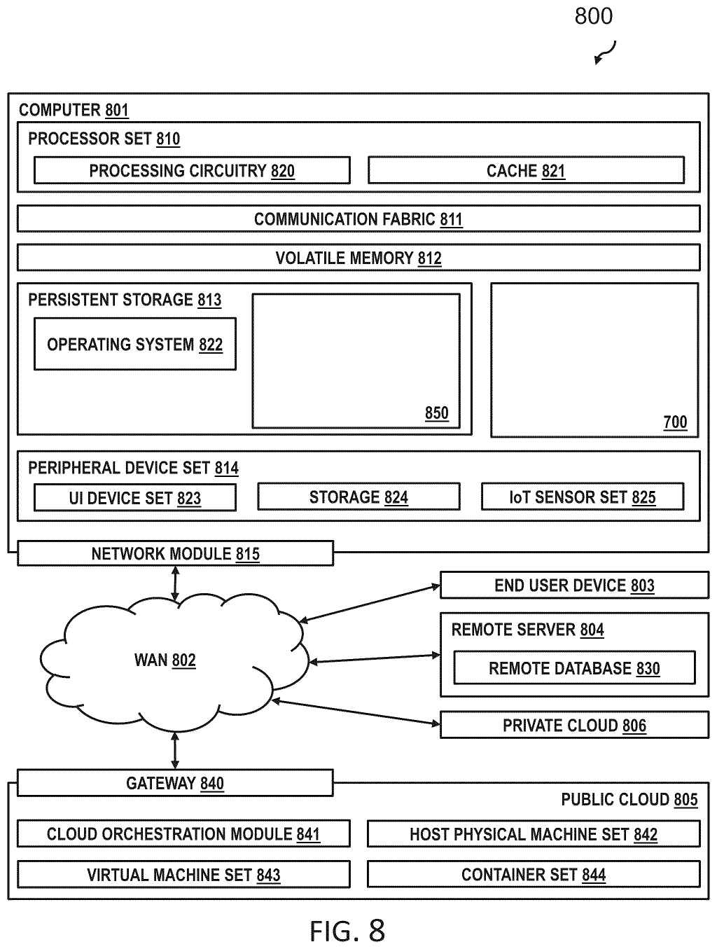

FIG. 8 shows a computing environment 800 comprising an example of an environment for the execution of at least some of the computer code 850 involved in performing the inventive methods, such as the method 100 for privacy preserving authentication augmented with physical biometric proof.

In addition to block 850, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 850, as identified above), peripheral device set 814 (including user interface (UI), device set 823, storage 824, and Internet of Things (IOT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 850 in persistent storage 813.

COMMUNICATION FABRIC 811 is the signal conduction paths that allow the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, the volatile memory is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface type operating systems that employ a kernel. The code included in block 850 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (e.g., embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

It should also be mentioned that parts of the authentication system 700 for privacy preserving authentication augmented with physical biometric proof (compare FIG. 7) can be an operational sub-system of the computer 801 and may be attached to a computer-internal bus system. Other parts of the authentication system 700 for privacy preserving authentication augmented with physical biometric proof can be implemented together with another similar computer 801.

The terminology used herein is for the purpose of describing particular embodiments only and is not intended to limit the invention. As used herein, the singular forms “a”, “an” and “the” are intended to include the plural forms as well, unless the context clearly indicates otherwise. It will further be understood that the terms comprises and/or comprising, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description, but is not intended to be exhaustive or limited to the invention in the form disclosed. Many modifications and variations will be apparent to those of ordinary skills in the art without departing from the scope and spirit of the invention. The embodiments are chosen and described in order to best explain the principles of the invention and the practical application, and to enable others of ordinary skills in the art to understand the invention for various embodiments with various modifications, as are suited to the particular use contemplated.

Finally, the inventive can be summaries by the following clauses:

1. A computer-implemented method for privacy preserving authentication augmented with physical biometric proof, the method comprising
providing an integrated smart entity comprising both, a visual indicator of a physical entity and a persistent memory storing picture identifier data, wherein the visual indicator and the persistent memory are physically inseparable,
comparing the visual indicator and a related feature of the physical entity to be authenticated,
scanning, by a verifier unit, the integrated smart entity, and
receiving, by the verifier unit, an output value of a function having the picture identifier data as argument,
receiving, by the verifier unit, a verifiable credential,
upon determining, by the verifier unit, that the output value of the function and the received verifiable credential are satisfying a matching predicate,
confirming the verifiable credential.
   2. The method according to clause 1, wherein the integrated smart entity is a near-field communication card.
   3. The method according to clause 1 or 2, wherein the received verifiable credential that the verifier unit has received was sent by a holder unit.
   4. The method according to any of the preceding clauses, wherein the visual indicator is an image of a person, an image of a face of a person, an image of a fingerprint of a person, an image of an object, an image of a text, an image of a pictogram, a bar code, and a QR-code.
   5. The method according to any of the preceding clauses, also comprising
issuing, by a first trusted authority, the integrated smart entity with a unique picture identifier stored in the persistent memory, and
issuing, by a second trusted authority the verifiable credential, wherein one attribute of the verifiable credential is the unique picture identifier.
   6. The method according to clause 5, also comprises
generating, by the trusted authority, a key pair of a signature scheme that supports an efficient signature proof of knowledge and a selected disclosure of a subset of related messages, and
sharing a related verification key with the holder unit and the verifier unit.
   7. The method according to clause 5, wherein the first trusted authority issuing the integrated smart entity and the second trusted authority issuing the verifiable credential are either the same trusted authorities or different trusted authorities.
   8. The method according to clause 3 to 7, wherein the holder unit is a smartphone, and/or wherein the verifier unit is a smartphone.
   9. The method according to any of the preceding clauses, wherein the determining, by the verifier unit, that the output value of the function and the received verifiable credential are satisfying the matching predicate, a Fiat-Shamir transformed Schnorr proof of knowledge algorithm is used.
   10. The method according to any of the preceding clauses, wherein the holder unit and/or the verifier unit is one selected out of the group comprising a smartwatch, a table computer, a notebook computer or a dedicated device for authentication purposes.
   11. An authentication system for privacy preserving authentication augmented with physical biometric proof, the system comprising
an integrated smart entity comprising both, a visual indicator of a physical entity and a persistent memory storing picture identifier data, wherein the visual indicator and the persistent memory are physically inseparable,
a holder unit,
a verifier unit,
a comparing device adapted for comparing the visual indicator and a related feature of the physical entity to be authenticated,
a scanner module connected to the verifier unit, wherein the scanner unit is adapted to receive data from the integrated smart entity, by scanning the integrated smart entity, thereby receiving an output value of a function having the picture identifier data as argument,
a receiver connected the verifier unit, wherein the receiver is adapted for receiving a verifiable credential,
a determination unit as part of the verifier unit adapted for upon determining that the output value of the function and the received verifiable credential are satisfying a matching predicate, confirming the verifiable credential.
   12. The system according to clause 11, wherein the integrated smart entity is a near-field communication card.
   13. The system according to clause 11 or 12, wherein the received verifiable credential that the scanner module of the verifier unit has received was sent by the holder unit.
   14. The system according to any of the clauses 11 to 14, wherein the visual indicator is an image of a person, an image of a face of a person, an image of a finger print of a person, an image of an object, an image of a text, an image of a pictogram, a bar code, and a QR-code.
   15. The system according to any of the clauses 11 to 14, also comprising
a first trusted authority system adapted for generating the integrated smart entity with a unique picture identifier stored in the persistent memory, and
a second trusted authority system adapted for generating the verifiable credential, wherein one attribute of the verifiable credential is the unique picture identifier.
   16. The system according to clause 15, wherein the first trusted authority is also enabled for
generating a key pair of a signature scheme that supports an efficient signature proof of knowledge and a selected disclosure of a subset of related messages, and
sharing a related verification key with the holder unit and the verifier unit.
   17. The system according to clause 15, wherein the first trusted authority system and the second trusted authority system are either the same trusted authorities systems or different trusted authorities systems.
   18. The system according to any of the clauses 11 to 17, wherein the holder unit is a smartphone, and/or wherein the verifier unit is a smartphone.
   19. The method according to any of the clauses 11 to 18, wherein the determining, by the verifier unit, that the output value of the function and the received verifiable credential are satisfying the matching predicate a Fiat-Shamir transformed Schnorr proof of knowledge algorithm is used.
   20. A computer program product for privacy preserving authentication augmented with physical biometric proof, the computer program product comprising a computer readable storage medium having program instructions embodied therewith, the program instructions being executable by one or more computing systems or controllers to cause the one or more computing systems to
generate an integrated smart entity comprising both, a visual indicator of a physical entity and a persistent memory storing picture identifier data, wherein the visual indicator and the persistent memory are physically inseparable,
compare the visual indicator and a related feature of the physical entity to be authenticated,
scanning, by a verifier unit, the integrated smart entity, and
receiving by the verifier unit, an output value of a function having the picture identifier data as argument,
receive, by the verifier unit, a verifiable credential,
upon determining, by the verifier unit, that the output value of the function and the received verifiable credential are satisfying a matching predicate,
confirming the verifiable credential.

What is claimed is:

1. A computer-implemented method comprising:
providing an integrated smart entity comprising both, a visual indicator of a physical entity and a persistent memory storing picture identifier data, wherein said visual indicator and said persistent memory are physically inseparable;
comparing said visual indicator and a related feature of said physical entity to be authenticated;
receiving an output value of a function having said picture identifier data as argument and a verifiable credential; and
upon determining that said output value of said function and said received verifiable credential satisfy a matching predicate, confirming said verifiable credential.

2. The computer-implemented method of claim 1, wherein said integrated smart entity is a near-field communication card.

3. The computer-implemented method of claim 1, wherein said received verifiable credential was sent by a holder unit.

4. The computer-implemented method of claim 1, wherein said visual indicator is an image of a person, an image of a face of a person, an image of a fingerprint of a person, an image of an object, an image of a text, an image of a pictogram, a bar code, and a QR-code.

5. The computer-implemented method of claim 1, further comprising:
issuing, by a first trusted authority, said integrated smart entity with a unique picture identifier stored in said persistent memory, and
issuing, by a second trusted authority said verifiable credential, wherein one attribute of said verifiable credential is said unique picture identifier.

6. The computer-implemented method of claim 5, further comprising:
generating, by said trusted authority, a key pair of a signature scheme that supports an efficient signature proof of knowledge and a selected disclosure of a subset of related messages, and
sharing a related verification key with said holder unit and a verifier unit.

7. The computer-implemented method of claim 5, wherein said first trusted authority issuing said integrated smart entity and said second trusted authority issuing said verifiable credential are either said same trusted authorities or different trusted authorities.

8. The computer-implemented method of claim 3, wherein said holder unit is a smartphone.

9. The computer-implemented method of claim 1, wherein said determining that said output value of said function and said received verifiable credential satisfy said matching predicate using a Fiat-Shamir transformed Schnorr proof of knowledge algorithm.

10. The computer-implemented method of claim 5, wherein said holder unit and said verifier unit is one selected out of said group comprising a smartwatch, a table computer, a notebook computer or a dedicated device for authentication purposes.

11. An authentication system comprising:
an integrated smart entity comprising both, a visual indicator of a physical entity and a persistent memory storing picture identifier data, wherein said visual indicator and said persistent memory are physically inseparable;
a holder unit;
a verifier unit;
a comparing device adapted for comparing said visual indicator and a related feature of said physical entity to be authenticated;
a scanner module connected to said verifier unit, wherein said scanner unit is adapted to receive data from said integrated smart entity, by scanning said integrated smart entity, thereby receiving an output value of a function having said picture identifier data as argument;
a receiver connected said verifier unit, wherein said receiver is adapted for receiving a verifiable credential; and
a determination unit as part of said verifier unit adapted for upon determining that said output value of said function and said received verifiable credential are satisfying a matching predicate, confirming said verifiable credential.

12. The authentication system of claim 11, wherein said integrated smart entity is a near-field communication card.

13. The authentication system of claim 11, wherein said received verifiable credential that said scanner module of said verifier unit has received was sent by said holder unit.

14. The authentication system of claim 11, wherein said visual indicator is an image of a person, an image of a face of a person, an image of a fingerprint of a person, an image of an object, an image of a text, an image of a pictogram, a bar code, and a QR-code.

15. The authentication system of claim 11, further comprising:
a first trusted authority system adapted for generating said integrated smart entity with a unique picture identifier stored in said persistent memory; and
a second trusted authority system adapted for generating said verifiable credential, wherein one attribute of said verifiable credential is said unique picture identifier.

16. The authentication system of claim 15, wherein said first trusted authority is also enabled for generating a key pair of a signature scheme that supports an efficient signature proof of knowledge and a selected disclosure of a subset of related messages, and sharing a related verification key with said holder unit and said verifier unit.

17. The authentication system of claim 15, wherein said first trusted authority system and said second trusted authority system are either said same trusted authorities systems or different trusted authorities systems.

18. The authentication system of claim 11, wherein said holder unit is a smartphone, and aid verifier unit is a smartphone.

19. The authentication system of claim 11, wherein said determining, by said verifier unit, that said output value of said function and said received verifiable credential are satisfy said matching predicate using a Fiat-Shamir transformed Schnorr proof of knowledge algorithm.

20. A computer program product comprising:
one or more computer readable storage media and program instructions stored on the one or more computer readable storage media, the program instructions comprising:
program instructions to generate an integrated smart entity comprising both, a visual indicator of a physical entity and a persistent memory storing picture identifier data, wherein said visual indicator and said persistent memory are physically inseparable;
program instructions to compare said visual indicator and a related feature of said physical entity to be authenticated;
program instructions to receive an output value of a function having said picture identifier data as argument a verifiable credential; and
program instructions to upon determining that said output value of said function and said received verifiable credential satisfy a matching predicate, confirming said verifiable credential.
